(19) United States
(12) Patent Application Publication
(10) Pub. No.: US 2014/0068171 A1
(43) Pub. Date: Mar. 6, 2014

(54) REFRESH CONTROL CIRCUIT AND SEMICONDUCTOR MEMORY DEVICE INCLUDING THE SAME

(71) Applicant: SK HYNIX INC., Gyeonggi-do (KR)

(72) Inventor: Yo-Sep LEE, Gyeonggi-do (KR)

(73) Assignee: SK hynix Inc., Gyeonggi-do (KR)

(21) Appl. No.: 13/717,470

(22) Filed: Dec. 17, 2012

(30) Foreign Application Priority Data
Aug. 30, 2012 (KR) 10-2012-0095369

(51) Int. Cl. G06F 13/16

(52) U.S. Cl. CPC G06F 13/1636
USPC 711/106

(57) ABSTRACT

A refresh control circuit includes an internal chip information unit configured to provide internal chip information related to a retention characteristic of a memory cell, a mode information modification unit configured to output modified mode information based on the internal chip information, wherein the modified mode information represent a number of memory banks for refresh operation, and a selection signal activation unit configured to activate one or more of selection signals for selecting corresponding one or more of the memory banks in response to the modified mode information.

### CROSS-REFERENCE TO RELATED APPLICATION

The present application claims priority of Korean Patent application No, 10-2012-0095369, filed on Aug. 30, 2012, which is incorporated herein by reference in its entirety.

### BACKGROUND

1. Field

Exemplary embodiments of the present invention relate to a semiconductor design technology, and more particularly, a refresh control circuit and a semiconductor memory device including the same for adjusting a period of refresh operation performed on a memory cell.

2. Description of the Related Art

A memory cell of a dynamic random access memory (DRAM) includes a transistor and a capacitor. The storage of data depends on voltage of the capacitor. The stored data is lost due to charge loss of the capacitor. In order to prevent the charge toss, the capacitor is fully recharged before the charge loses. This recharge operation is referred as “refresh”. There are two types of refresh operation: auto refresh operation and self-refresh operation.

The refresh operation leads to power consumption of integrated circuit. Prior art to reduce the power consumption due to refresh operation will be described by referring to FIG. 1.

FIG. 1 is a block diagram illustrating a conventional semiconductor memory device that adjusts a number of memory banks for performing refresh operations in response to a single refresh command based on mode information.

As shown in FIG. 1, a conventional semiconductor memory device includes memory bank groups 31 to 34, a selection signal activation unit 10 and a row address counter 20.

Each of the memory bank groups 31 to 34 includes at least one memory bank.

Each of the memory bank groups 31 to 34 is selected in response to corresponding bank group selection signals BKG_ACT1 to BKG_ACT4.

Hereinafter, for the convenience of descriptions, each of the memory bank groups 31 to 34 is one memory bank.

The selection signal activation unit 10 activates the bank group activation signals BKG_ACT1 to BKG_ACT4 which select the memory bank groups 31 to 34 for performing refresh operation in response to mode information MODE_INF. The mode information MODE_INF indicates one of 3 modes. When the mode information MODE_INF indicates the first (1st) mode, the refresh operations on all of memory bank groups 31 to 34 are performed. When the mode information MODE_INF indicates the second (2nd) mode, the refresh operations on a pair of memory bank groups 31 to 34 are performed. When the mode information MODE_INF indicates the 3rd mode, the refresh operations on each of memory bank groups 31 to 34 are performed. Each refresh operation is performed in response to application of an activated refresh pulse REFP.

The refresh pulse REFP is activated based on a refresh command.

The row address counter 20 changes a row address RADD based on every preset number of application of an activated refresh pulse REFP. The preset number depends on the value of the mode information MODE_INF.

In the 1st mode, whenever the refresh pulse REFP is applied, the row address RADD is changed. In the 1st mode, a row address RADD may have a value of ‘0’. When an activated refresh pulse REFP is applied at the 1st time, the roam address counter 20 changes the value of the row address RADD ‘0’ to ‘1’. When the activated refresh pulse REFP is applied secondarily, the row address counter 20 changes the value of the row address RADD ‘1’ to ‘2’.

In the 2nd mode, the value of the row address RADD is changed at a time the refresh pulse REFP is applied for the second time. In the 2nd mode the row address RADD may have a value of ‘0’. When the activated refresh pulse REFP is applied at the 1st time, the row address counter 20 retains the row address of the value ‘0’, and when the activated refresh pulse REFP is applied secondarily, the row address counter 20 changes the value of the row address RADD ‘0’ to ‘1’. That is, the row address counter 20 changes sequentially the value of the row address RADD at a time the activated refresh pulse REFP is applied for the second time.

In the third (3rd) mode, the value of the row address RADD is changed at a time the refresh pulse REFP is applied for the fourth time. In the 3rd mode the row address RADD may have the value of ‘0’. When the activated refresh pulse REFP is applied at the 1st time, 2nd 1.0 time and 3rd time, the row address counter 20 retains the row address RADD of the value ‘0’. When the activated refresh pulse REFP is applied at the fourth (4th) time, the row address counter 20 changes the value of the row address RADD ‘0’ to ‘1’. That is, the row address counter 20 changes sequentially the value of the row address RADD at every 4th time of the application of the activated refresh pulse REFP.

The row address counter 20 changes the row address RADD after refresh cycle period tRFC elapse from the time of application of the refresh pulse REFP (i.e. after the refresh operation is performed).

Here, a refresh cycle period tRFC represents a time point when the refresh operation is completed for a specific word line of all banks in the semiconductor memory device in response to the activation of the refresh pulse REFP. The refresh cycle period tRFC is included in an average periodic refresh interval tRFI.

The average periodic refresh interval tRFC represents an average activation interval of the refresh pulse. The average periodic refresh interval tRFI may be said to comprise the refresh cycle period tRFC and a period for read/write operation.

The refresh cycle period tRFC and the average periodic refresh interval tRFI are varied based on the mode information MODE_INF.

In the present description, the refresh cycle period and the average periodic refresh interval in each of 1st to 3rd modes are respectively defined as tRFC1 and tRFI1, tRFC2 and tRFI2, and tRFC3 and tRFI3.

The row address counter 20 changes the value of the row address RADD sequentially after the refresh cycle period tRFC1 (in the 1st mode), tRFC2 (in the 2nd mode), or tRFC3 (in the 3rd mode) elapses from the time point of every 1st (in the 1st mode), 2nd (in the 2nd mode), or 4th (in the 3rd mode) application of the activated refresh pulse REFP.

FIGS. 2A to 2C are timing diagrams illustrating refresh operation performed on a conventional semiconductor memory device shown in FIG. 1, each of which indicates the each of 1st to 3rd modes.

Referring to FIG. 1 and FIG. 2A, in the 1st mode, the refresh pulse REFP is activated and applied with the average periodic refresh interval tRFI1.

If the activated refresh pulse REFP is applied at the 1st time, the selection signal activation unit 10 outputs activated bank group selection signals BKG_ACT1 to BKG_ACT4 to each of the memory bank groups 31 to 34.

The four of the memory bank group 31 to 44 are selected in response to the activated four of the bank group selection signals BKG_ACT1 to BKG_ACT4. In the selected memory bank group, refresh operation is performed for a word line corresponding to the row address RADD of a value ‘0’.

The row address counter 20 changes sequentially the row address RADD whenever the activated refresh pulse REFP is applied once in the 1st mode.

The row address counter 20 changes the value of the row address RADD ‘0’ to ‘1’ after the refresh cycle period tRFC1 elapses from the time point of every application of the activated refresh pulse REFP.

In the 1st mode, the activated refresh pulse REFP is applied secondarily after the average periodic refresh interval tRFI1 elapses from the time point of applying the activated refresh pulse REFP at the 1st time.

At every time the activated refresh pulse REFP is applied with the refresh cycle period tRFC1 the value of the row address RADD is sequentially changed. The above-described refresh operation is repeated.

FIG. 2B is a timing diagram illustrating refresh operation in the 2nd mode. The refresh pulse REFP is activated and applied with the average periodic refresh interval tRFI2.

Referring to FIGS. 1 and 2B, if the activated refresh pulse REFP is applied at the 1st time, the selection signal activation unit 10 activates 2 (for example, the bank group selection signals BKG_ACT1 and BKG_ACT2) out of the bank group selection signals BKG_ACT1 to BKG_ACT4 in the 2nd mode.

2 memory banks (for example, memory banks 31 and 32) are selected in response to an activated bank group selection signals BKG_ACT1 and BKG_ACT2.

In each of the selected memory banks, Refresh operation is performed for a word line corresponding to the row address RADD of a value ‘0’ out of a plurality of word lines.

In the 2nd mode, the row address counter 20 changes the value of the row address after the refresh cycle period tRFC2 elapses from every 2nd time point of application of the activated refresh pulse REFP. Accordingly if the activated refresh pulse REFP is applied at the 1st time, the row address counter 20 retains the row address the having the value of ‘0’.

In the 2nd mode, the activated refresh pulse REFP is applied at the 2nd time after the average periodic refresh interval tRFI2 elapses from the time point of applying the activated refresh pulse REFP at the 1st time.

If the activated refresh pulse REFP is applied at the 2nd time, the selection signal activation unit 10 activates the other two (for example, bank group selection signals BKG_ACT3 and BKG_ACT4) out of the four bank group selection signals BKG_ACT1 to BKG_ACT4.

The two banks (for example, memory banks 33 and 34) are selected in response to an activated bank group selection signals BKG_ACT3 and BKG_ACT4.

In each of the selected memory banks, refresh operation is performed for a word line corresponding to the row address RADD of a value ‘0’ out of a plurality of word lines.

In the 2nd mode, the row address counter 20 changes the value of the row address RADD ‘0’ to ‘1’ after the refresh cycle period tRFC2 elapses from the time point of applying the activated refresh pulse REFP at the 2nd time.

The activated refresh pulse REFP is applied at the 3rd time after the average periodic refresh interval tRFI2 elapses from the time point of applying the activated refresh pulse REFP at the 2nd time. Above-described process is repeated.

FIG. 2C is a timing diagram illustrating refresh operation in the 3rd mode. The refresh pulse REFP is activated and applied with the average periodic refresh interval tRFI3.

Referring to FIGS. 1 and 2C, if the activated refresh pulse REFP is applied at the 1st time, the selection signal activation unit 10 activates one (for example, the bank group selection signal BKG_ACT1) out of the bank group selection signals BKG_ACT1 to BKG_ACT4 in the 3rd mode.

One memory bank (for example, the memory bank 31) is selected in response to an activated bank group selection signal BKG_ACT1. In the selected memory bank, refresh operation performed for a word line corresponding to the row address RAID of a value ‘0’ out of a plurality of word lines.

In the 3rd mode, the row address counter 20 changes sequentially the row address after the refresh cycle period tRFC3 elapses from every 4th time point of application of the activated refresh pulse REFP. Accordingly, if the activated refresh pulse REFP is applied at the 1st, 2nd, and 3rd time, the row address counter 20 retains the row address the having the value of 0′. In the 3rd mode, the above-described process is repeated according to the application of the activated refresh pulse REFP and change of the row address.

The convention semiconductor memory device controls refresh operation irrespective of a data retention characteristic.

If refresh operation of the 1st mode is performed with a short period interval when a memory cell has a long retention time, the refresh operation leads to unnecessary power consumption. The retention time, which is a time for that data stored in a memory cell to be retained on the memory cell without refresh operation.

Meanwhile, if refresh operation of the 3rd mode is performed with a long period interval when a memory cell has a short retention time, the data stored in the memory cell is in the risk of being erased.

When a memory cell has a long retention time, it is not necessary to perform refresh operation often, and when a memory cell has a short retention time, t is necessary to perform refresh operation with adequate period. Thus, a period of refresh operation may be adjusted based on a retention characteristic of a memory cell.

### SUMMARY

Exemplary embodiments of the present invention are directed to a refresh control circuit and a semiconductor memory device including the same for controlling refresh operations according to modified mode information based on the characteristics having an influence on a retention time of a memory cell.

In accordance with an embodiment of the present invention, a refresh control circuit includes an internal chip information unit configured to provide internal chip information related to a retention characteristic of a memory cell; a mode information modification unit configured to output modified mode information based on the internal chip information, wherein the modified mode information represent a number of memory banks for refresh operation; and a selection signal activation unit configured to activate one or more of selection signals for selecting corresponding one or more of the memory banks in response to the modified mode information.

In accordance with another embodiment of the present invention, a semiconductor memory device includes N number of bank groups having at least one bank; an internal chip information unit configured to provide internal chip information related to a retention characteristic of a memory cell; a mode information modification unit configured to output modified mode information based on the internal chip information, wherein the modified mode information represent a number of bank groups for refresh operation; a selection signal activation unit configured to activate one or more of selection signals for selecting corresponding one or more of the bank groups in response to the modified mode information; and a row address counter configured to change a value of a row address at every preset number of application of single refresh pulse, wherein the preset number is the number of average periodic refresh interval to complete single refresh operation on all of the N bank groups of the memory cell corresponding to the modified mode information.

### BRIEF DESCRIPTION OF THE DRAWINGS

FIG. 1 is a block diagram illustrating a conventional semiconductor memory device, which adjusts a number of memory banks for performing refresh operation at a time in response to refresh command based on mode information.

FIGS. 2A to 2C are timing diagrams illustrating refresh operation performed on a conventional semiconductor memory device shown in FIG. 1.

FIG. 3 is a semiconductor memory device in accordance with an embodiment of the present application.

FIGS. 4A and 4B are block diagrams illustrating 1st and 2nd embodiments of an internal chip information unit shown in FIG. 3.

FIGS. 5A and 58 are timing diagrams illustrating a case that it is adjusted to less frequently perform refresh operations based on an internal chip information of the semiconductor memory device shown in FIG. 3.

FIGS. 6A and 6B are timing diagrams illustrating a case that it is adjusted to more frequently perform refresh operations based on an internal chip information of the semiconductor memory device shown in FIG. 3.

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, reference numerals correspond directly to the like numbered parts in the various figures and embodiments of the present invention. In addition, a singular form may include a plural form as long as it is not specifically mentioned in a sentence.

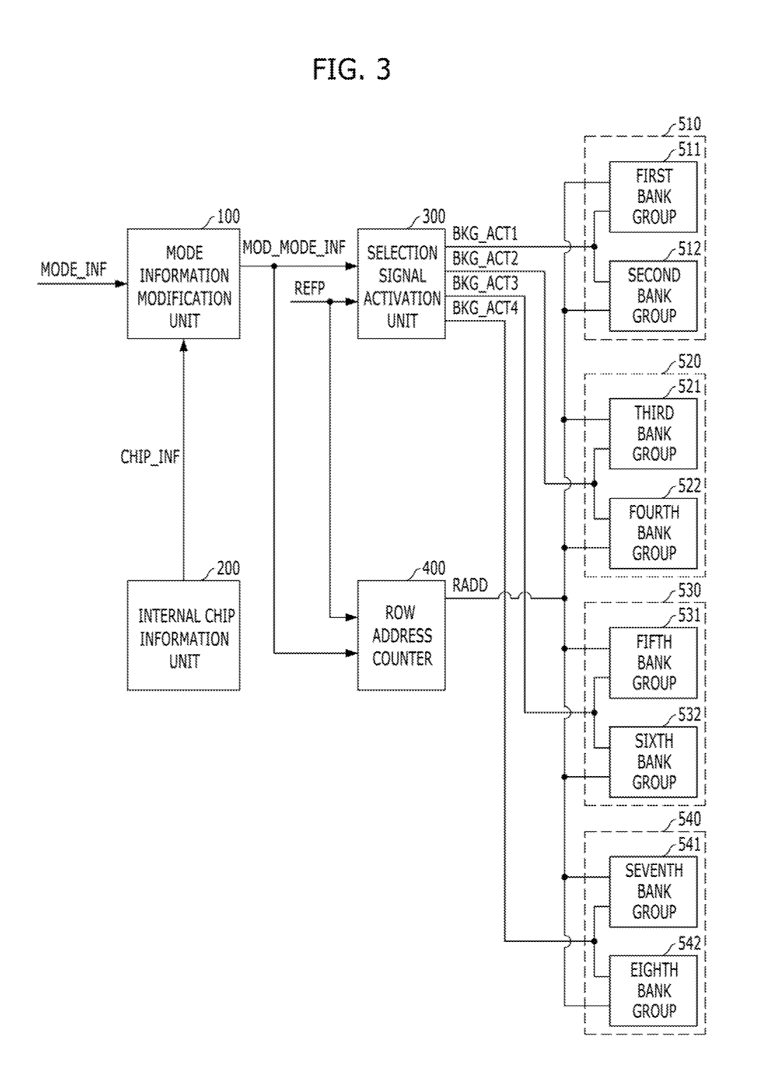

FIG. 3 is a semiconductor memory device accordance with an embodiment of the present application.

As shown in FIG. 3, a semiconductor memory device in accordance with an embodiment of the present application includes a plurality of memory bank groups 510 to 540, an internal chip information unit 200, a mode information modification unit 100, a selection signal activation unit 300 and a row address counter 400.

The memory bank groups 510-540 each include at least one memory bank. As shown in FIG. 3, for the convenience of the descriptions, the semiconductor memory device includes four memory bank groups 510 to 540 each of which has two memory banks, in total of 8 memory banks 511, 512, 521, 522, 531, 532, 541 and 542.

Each of the memory banks 511, 512, 521, 522, 531, 532, 541 and 542 includes memory cells whose size may vary. Hereinafter, for the convenience of the descriptions, it will be assumed that each of the memory banks 511, 512, 521, 522, 531, 532, 541 and 542 includes memory cells with same size.

Each of the bank groups 510 to 540 is selected in response to corresponding bank group selection signal among the signals BKG_ACT1 to BKG_ACT4. For example, in response to the activated 1st bank group selection signal BKG_ACT1, the 1st bank group 510, or the 1st and 2nd memory banks 511 and 512 are selected.

The internal chip information unit 200 provides internal chip information CHIP_INF representing characteristic (“retention characteristic”) that influences on a retention time of a memory cell, such as temperature and process.

The retention characteristic of the memory cell is provided to the internal chip information unit 200. The information of the retention characteristic represents that the retention time is longer or shorter than a reference period. The internal chip information unit 200 provides the information of the retention characteristic as the internal chip information CHIP_INF. In another embodiment, the internal chip information CHIP_INF may include the temperature information which represents an internal temperature of the chip. Since a leakage current is changed in the memory cell when a temperature changes, the retention time of the memory cell is reduced.

The mode information modification unit 100 receives mode information MODE_INF, modifies the mode information MODE_INF using the internal chip information CHIP_INF and outputs modified mode information MOD_MODE_INF. The mode information MODE_INF is used to adjust a number of memory bank groups involved with refresh operation in response to a single refresh command.

The mode information MODE_INF indicates one of three modes. When the mode information MODE_INF indicates the 1st mode, the refresh operations on all of memory bank groups 510 to 540 are performed. When the mode information MODE_INF indicates the 2nd mode, the refresh operations on a pair of memory bank groups 510 to 540 are performed. When the mode information MODE_INF indicates the 3rd mode, the refresh operations on each of memory bank groups 510 to 540 are performed. Each refresh operation is performed in response to application of an activated refresh pulse REFP.

In each of the three modes, the refresh command is received from an external device with each of average periodic refresh internals tRFI1 to tRFI3, which means that the refresh pulse REFP is activated and applied with each of the average periodic refresh intervals tRFI1 to tRFI3. The mode information MODE_INF may be generated by a mode register set (not shown), and may be based on a combination of a command signal and an address signal received from the external device.

The mode information modification unit 100 may be designed to modify the mode information MODE_INF as described in 1st to 3rd tables.

1st TABLE

| Information | | | |
|---|---|---|---|
| of the | Mode | Modified mode | Period interval |
| retention | information | information | change of |
| characteristic | MODE_INF | MOD_MODE_INF | refresh operation |
| Long | 1st mode | 2nd mode | tRFI 1 to tRFI 1 × 2 |
| retention | 2nd mode | 3rd mode | tRFI 2 to tRFI 2 × 4 |
| time | 3rd mode | 3rd mode | No change |
| Short | 1st mode | 1st mode | No change |
| retention | 2nd mode | 2nd mode | No change |
| time | 3rd mode | 3rd mode | No change |

The 1st table represents a 1st embodiment of the modified mode information MOD_MODE_INF generated by the mode information modification unit 100 in case that the internal chip information CHIP_INF represents the longer retention time than a reference time.

The modified mode information MOD_MODE_INF of the 1st table represents that the original refresh mode among three modes is changed to another mode whose refresh period in a memory bank group is longer without changing the original average periodic refresh interval tRFI. The refresh period in a memory bank group represents time interval between previous refresh operation and next refresh operation in a memory bank group.

For example, in case of the 1st table, the mode information modification unit 100 modifies the mode information MODE_INF so that the 1st mode is changed to 2nd mode whose refresh period in a memory bank group is longer without changing the original average periodic refresh interval tRFI1.

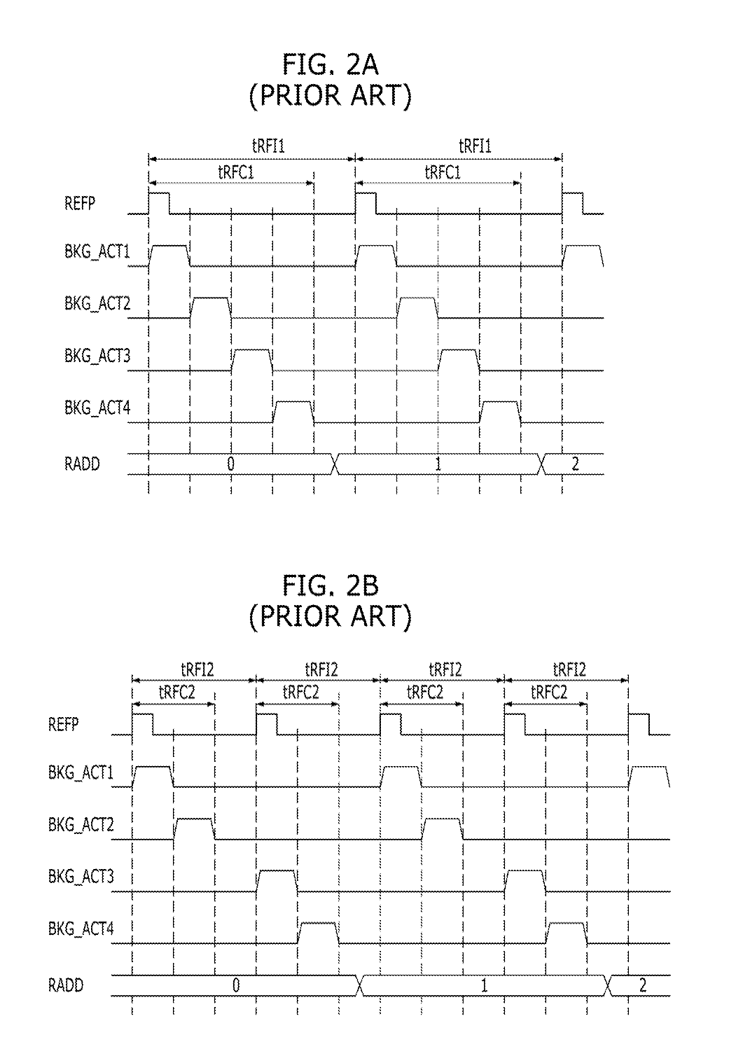

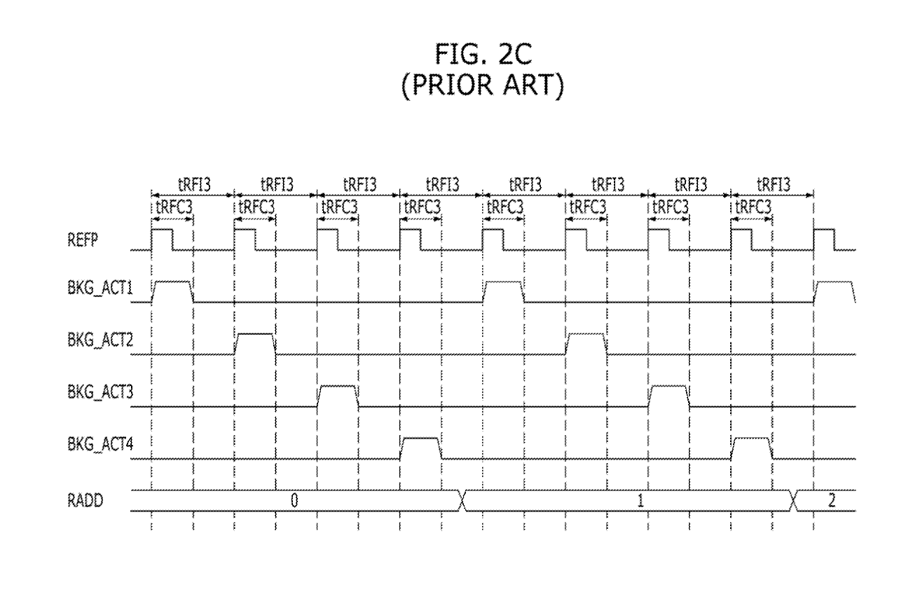

As known from FIGS. 2A to 2C, in each of 3 refresh mode, single refresh operation on all of the memory bank groups is completed with different number of average periodic refresh interval tRFI, namely with one of the average periodic refresh interval tRFI1 in the 1st mode; with two of the average periodic refresh interval tRFI2 in the 2nd mode; and with four of the average periodic refresh interval tRFI3 in the 3rd mode. If the average periodic refresh interval tRFI is unchanged, the refresh period in a memory bank group in 2nd mode is longer than the refresh period in a memory bank group in 1st mode, and the refresh period in a memory bank group in 3rd mode is longer than the refresh period in a memory bank group in 2nd mode. This is because the number of the average periodic refresh interval tRFI to complete single refresh operation on all of the memory bank groups is different.

For example, in case of the 1st table, when the mode information MODE_INF represents the 1st mode, the modified mode information MOD_MODE_INF represents the 2nd mode. Thus, the refresh period in a memory bank group becomes tRFI1×2 and expands two times as much as that of performing the refresh operation of the original 1st mode.

If the mode information MODE_INF represents the 3rd mode, the mode information modification unit 100 generates the modified mode information MOD_MODE_INF that represents the same 3rd mode without changing the mode information MODE_INF. If the information of the retention characteristic represents that the retention time of the memory cell is shorter than the reference time, the mode information modification unit 100 does not change the mode information MODE_INF.

The mode information modification unit 100 may be designed to modify the mode information MODE_INF as described in a second table.

2nd TABLE

| Information | | | |
|---|---|---|---|
| of the | Mode | Modified mode | Period interval |
| retention | information | information | change of |
| characteristic | MODE_INF | MOD_MODE_INF | refresh operation |
| Long | 1st mode | 1st mode | No change |
| retention | 2nd mode | 2nd mode | No change |
| time | 3rd mode | 3rd mode | No change |
| Short | 1st mode | 1st mode | No change |
| retention | 2nd mode | 1st mode | tRFI 2 × 2 to tRFI 2 |
| time | 3rd mode | 2nd mode | tRFI 3 × 4 to tRFI |
| | | | 3 × 2 |

The 2nd table represents a 2nd embodiment of the modified mode information MOD_MODE_INF generated by the mode information modification unit 100 in case that the internal chip information CHIP_INF represents the shorter retention time than the reference time.

The modified mode information MOD_MODE_INF of the 2nd table represents that the original refresh mode among 3 modes is changed to another mode whose refresh period in a memory bank group is shorter without changing the original average periodic refresh interval tRFI.

For example, in case of the 2nd table, the mode information modification unit 100 generates the modified mode information MOD_MODE_INF so that the 2nd mode is changed to 1st mode whose refresh period in a memory bank group is shorter without changing the original average periodic refresh interval tRFI2.

In case of the 2nd table, when the mode information MODE_INF represents the 2nd mode, the modified mode information MOD_MODE_INF represents the 1st mode. Thus, the refresh period in a memory bank group becomes tRFI2 and shortens one-half times as much as that of performing the refresh operation of the original 2nd mode.

If the information of the retention characteristic represents that the retention time of the memory cell is longer than the reference time, the mode information modification unit 100 does not change the mode information MODE_INF.

The mode information modification unit 100 may be designed to modify the mode information MODE_INF as described in a third table.

3rd TABLE

| Information | | | |
|---|---|---|---|
| of the | Mode | Modified mode | Period interval |
| retention | information | information | change of |
| characteristic | MODE_INF | MOD_MODE_INF | refresh operation |
| Long | 1st mode | 2nd mode | tRFI 1 to tRFI 1 × 2 |
| retention | 2nd mode | 3rd mode | tRFI 2 × 2 to tRFI |
| time | | | 2 × 4 |
| | 3rd mode | 3rd mode | No change |
| Short | 1st mode | 1st mode | No change |
| retention | 2nd mode | 1st mode | tRFI 2 × 2 to tRFI 2 |
| time | 3rd mode | 2nd mode | tRFI 3 × 4 to tRFI |
| | | | 3 × 2 |

The 3rd table represents a 3rd embodiment of the modified mode information MOD_MODE_INF generated by the mode information modification unit 100 in case that the internal chip information CHIP_INF represents that the retention time is longer than a 1st reference time and shorter than a 2nd reference time (the 1st reference time is longer than the 2nd reference time).

For this case, if the information of the retention characteristic represents that the retention time of the memory cell is longer than the 1st reference time, the mode information modification unit 100 may be designed similarly to the case that the information of the retention characteristic has the long retention time as described in the 1st table. If the information of the retention characteristic represents that the retention time of the memory cell is shorter than the 2nd reference time, the mode information modification unit 100 may be designed similarly to the case that the information of the retention characteristic has the short retention time as described in the 2nd table.

If the internal chip information CHIP_INF has the temperature information, the mode information modification unit 100 may be designed to modify the mode information MODE_INF as described in fourth to sixth tables.

4th TABLE

| Information | | | |
|---|---|---|---|
| of the | Mode | Modified mode | Period interval |
| retention | information | information | change of |
| characteristic | MODE_INF | MOD_MODE_INF | refresh operation |
| Low | 1st mode | 2nd mode | tRFI 1 to tRFI 1 × 2 |
| temperature | 2nd mode | 3rd mode | tRFI 2 × 2 to tRFI |
| | | | 2 × 4 |
| | 3rd mode | 3rd mode | No change |
| High | 1st mode | 1st mode | No change |
| temperature | 2nd mode | 2nd mode | No change |
| | 3rd mode | 3rd mode | No change |

5th TABLE

| Information | | | |
|---|---|---|---|
| of the | Mode | Modified mode | Period interval |
| retention | information | information | change of |
| characteristic | MODE_INF | MOD_MODE_INF | refresh operation |
| Low | 1st mode | 1st mode | No change |
| temperature | 2nd mode | 2nd mode | No change |
| | 3rd mode | 3rd mode | No change |
| High | 1st mode | 1st mode | No change |
| temperature | 2nd mode | 1st mode | tRFI 2 × 2 to tRFI 2 |
| | 3rd mode | 2nd mode | tRFI 3 × 4 to tRFI |
| | | | 3 × 2 |

6th TABLE

| Information | | | |
|---|---|---|---|
| of the | Mode | Modified mode | Period interval |
| retention | information | information | change of |
| characteristic | MODE_INF | MOD_MODE_INF | refresh operation |
| Low | 1st mode | 2nd mode | tRFI 1 to tRFI 1 × 2 |
| temperature | 2nd mode | 3rd mode | tRFI 2 × 2 to tRFI |
| | | | 2 × 4 |
| | 3rd mode | 3rd mode | No change |
| High | 1st mode | 1st mode | No change |
| temperature | 2nd mode | 1st mode | tRFI 2 × 2 to tRFI 2 |
| | 3rd mode | 2nd mode | tRFI 3 × 4 to tRFI |
| | | | 3 × 2 |

The basic concepts of the 4th to sixth (6th) tables are same as those of the 1st to 3rd tables. The lower and higher temperature of the cases of the 4th to 6th tables respectively corresponds to the longer and shorter retention time of the cases of the 1st to 3rd tables. The lower and higher temperatures respectively represent the lower and higher temperatures of the memory cell compared to a reference temperature, or represent that the temperature of the memory cell is lower than a 1st reference temperature and higher than a 2nd reference temperature (the 1st reference temperature is lower than the 2nd reference temperature).

In case of the 4th table, the mode information modification unit 100 modifies the mode information MODE_INF so that the 1st mode is changed to 2nd mode whose refresh period in a memory bank group is longer without changing the original average periodic refresh interval tRFI1. When the mode information MODE_INF represents the 1st mode, the modified mode information MOD_MODE_INF represents the 2nd mode. Thus, the refresh period in a memory bank group becomes tRFI1×2 and expands two times as much as that of performing the refresh operation of the original 1st mode.

In case of the fifth (5th) table, the mode information modification unit 100 generates the modified mode information MOD_MODE_INF so that the 2nd mode is changed to 1st mode whose refresh period in a memory bank group is shorter without changing the original average periodic refresh interval tRFI2. When the mode information MODE_INF represents the 2nd mode, the modified mode information MOD_MODE_INF represents the 1st mode. Thus the refresh period in a memory bank group becomes tRFI2 and shortens one-half times as much as that of performing the refresh operation of the original 2nd mode.

For the case of 6th table, if the information of the retention characteristic represents that the temperature of the memory cell is lower than the 1st reference temperature, the mode information modification unit 100 may be designed similarly to the case that the information of the retention characteristic has the low temperature as described in the 4th table. If the information of the retention characteristic represents that the temperature of the memory cell is higher than the 2nd reference temperature, the mode information modification unit 100 may be designed similarly to the case that the information of the retention characteristic has the high temperature as described in the 5th table.

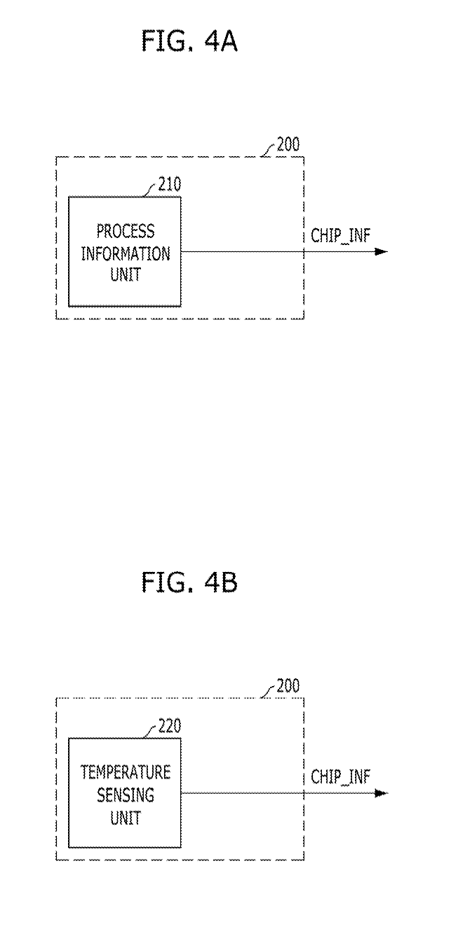

FIG. 4A is a block diagram illustrating a 1st embodiment of the internal chip information unit 200 shown in FIG. 3.

The internal chip information unit 200 includes a process information unit 210 for outputting internal chip information CHIP_INF that represents stored information of the retention characteristic. The chip information unit 210 stores process information of a chip at a wafer level, and after the chip is packaged, the chip information unit 210 outputs the internal chip information CHIP_INF which represents the stored process information or information of the retention characteristic. Here, as described above, the process information or information of the retention characteristic represents that the retention time of the memory cell is short or long.

More specifically, in case that the retention time of the memory cell measured at the wafer level is longer than a reference time, the internal chip information unit 200 stores the process information of the chip as data having the value of ‘1’, and in case that the retention time of the memory cell measured at the wafer level is shorter than a reference time, the internal chip information unit 200 stores the process information of the chip as data having the value of ‘0’.

For example, in case that the retention time, e.g., 128, of the memory cell measured at the wafer level is two times longer than a reference time, e.g., 64 ms, the internal chip information unit 200 may store the process information of the chip as data having the value of ‘1’, and in case that the retention time of the memory cell measured at the wafer level is not two times longer than the reference time, the internal chip information unit 200 may store the process information of the chip as data having the value of ‘0’.

The process information unit 210 may include a register or a fuse circuit such as multi-purpose register (MPR).

FIG. 4B is a block diagram illustrating a 2nd embodiment of the internal chip information unit 200 shown in FIG. 3.

The internal chip information unit 200 includes a temperature sensing unit 220 for sensing an internal temperature of a chip and outputting the internal chip information CHIP_INF having temperature information. The temperature information represents whether a detected internal temperature of the chip is higher than a reference temperature. The temperature sensing unit 220 includes an on die thermal sensor (ODTS). The detailed configuration of the ODTS is omitted since it is widely used for a skilled person in a related art. For example, if the internal temperature of the chip is higher than a reference temperature, the temperature sensing unit 220 outputs the internal chip information CHIP_INF which represents the temperature information having the value of ‘1’, and if the internal temperature of the chip is lower than the reference temperature, the temperature sensing unit 220 outputs the internal chip information CHIP_INF that represents the temperature information having the value of ‘0’.

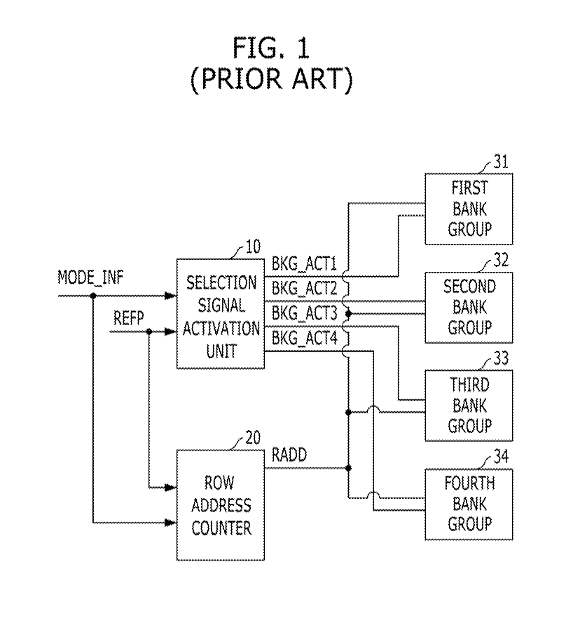

The operation of the selection signal activation unit 300 and the row address counter 400 is substantially the same as the selection signal activation unit 10 and the row address counter 20 of FIG. 1 except for the mode information modification unit 100 and internal chip information unit 200.

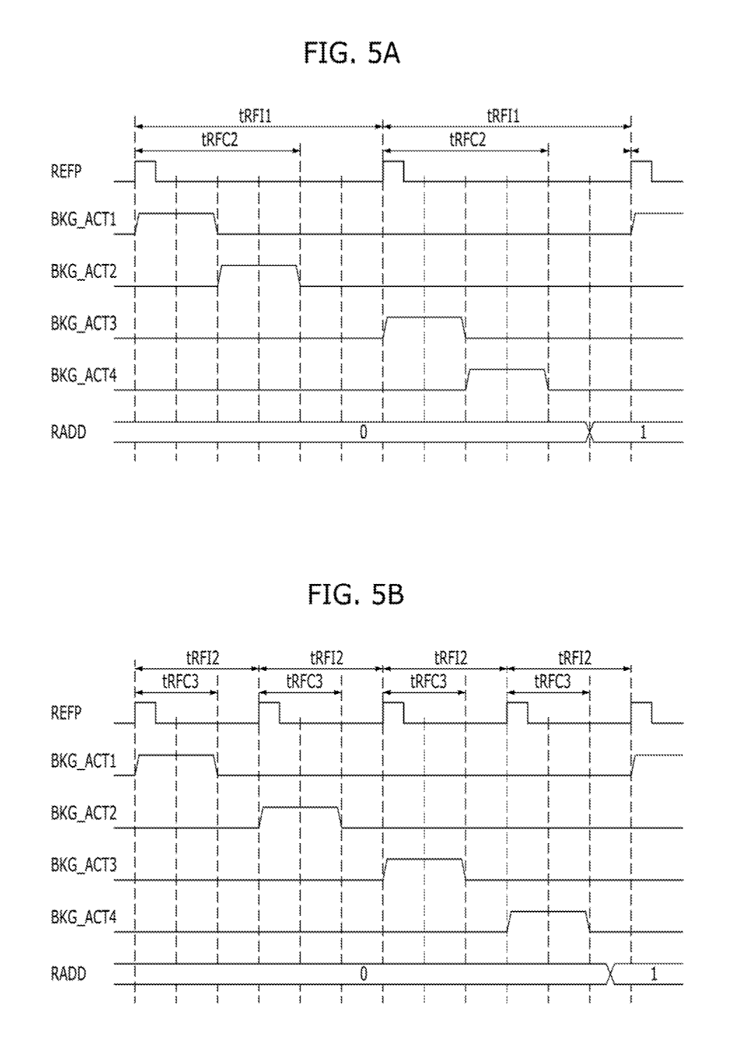

FIGS. 5A and 5B are timing diagrams illustrating a case that it is adjusted to less frequently perform refresh operations based on an internal chip information of the semiconductor memory device shown in FIG. 3.

For the convenience of the descriptions, it is assumed that the internal chip information CHIP_INF is the information of the retention characteristic with the value of ‘1’ and ‘0’: ‘1’ when the retention time of the memory cell is longer than the reference time, and ‘0’ when the retention time of the memory cell is shorter than the reference time.

FIG. 5A illustrates the case of the 1st table in which the internal chip information CHIP_INF represents that the retention time of the memory cell is longer than the reference time, and the mode information MODE_INF represents the 1st mode. It is assumed that an initial value of the row address RADD is ‘0’.

The internal chip information unit 200 outputs the internal chip information CHIP_INF, which represents the information of the retention characteristic having the value of ‘1’ to the mode information modification unit 100. The mode information modification unit 100 generates the modified mode information MOD_MODE_INF, which represents the 2nd mode, by modifying the mode information MOD_INF, which represents the 1st mode based on the internal chip information CHIP_INF.

When a refresh command REF_CMD is applied, the refresh pulse REFP is activated and input to the row address counter 400 and the selection signal activation unit 300.

Since the modified mode information represents the 2nd mode, if the activated refresh pulse REFP is applied at the 1st time, the selection signal activation unit 300 activates the 1st bank group selection signal BKG_ACT1 and the 2nd bank group selection signal BKGA_ACT2 out of bank group selection signals BKG_ACT1 to BKG_ACT4.

As shown in FIGS. 3 and 5A, if the activated refresh pulse REFP is activated at the 1st time, the 1st and 2nd bank group selection signals BKG_ACT1 and BKG_ACT2 are sequentially activated.

The 1st memory bank group 510 is selected in response to the activated 1st bank group selection signal BKG_ACT1, and the refresh operation is performed on the word line corresponding to the row address RADD having the value of ‘0’ out of the plurality of word lines included in each of the 1st and 2nd memory banks 511 and 512. The 2nd memory bank group 520 is selected in response to the activated 2nd bank group selection signal BKG_ACT2 and the refresh operation is performed on a word line corresponding to the row address RADD having the value of ‘0’ out of a plurality of word lines included in each of the 3rd memory bank 521 and the 4th memory bank 522.

Since the modified mode information MOD_MODE_INF represents the 2nd mode, the row address counter 400 changes sequentially the row address RADD every 2nd time of application of the activated refresh pulse REFP. Thus, the row address counter 400 retains the row address RADD having the value of ‘0’ if the activated refresh pulse REFP is applied at the 1st time.

Since the mode information MODE_INF represents the 1st mode, the refresh operation is performed by the 1st mode in view of outside. Thus, the refresh command is applied from an external source with the average periodic refresh interval tRFI1. That is, the refresh pulse REFP is activated with the average periodic refresh interval tRFI1 and is applied to the selection signal activation unit 300 and the row address counter 400. Thus, the activated refresh pulse REFP is activated at the second time after the average periodic refresh interval tRFI1 elapses from the time point of application of the activated refresh pulse REFP at the 1st time.

The selection signal activation unit 300 activates sequentially the 3rd and 4th bank group selection signals BKG_ACT3 and BKG_ACT4 in response to second application of the activated refresh pulse signal REFP.

The 3rd memory bank group 530 is selected in response to the activated 3rd bank group selection signal BKG_ACT3. The refresh operation is performed on the word line corresponding to the row address RADD having the value of ‘0’ out of the plurality of word fines included in each of the 5th and 6th memory banks 531 and 532.

The 4th memory bank group 540 is selected in response to the activated 4th bank group selection signal BKG_ACT4. The refresh operation is performed on the word line corresponding to the row address RADD having the value of ‘0’ out of the plurality of word lines included in each of the (7th) and eighth (8th) memory banks 541 and 542.

Since the modified mode information MOD_MODE_INF represents the 2nd mode, the row address counter 400 changes the row address RADD from the value of ‘0’ to ‘1’ after the refresh cycle period tRFC2 elapses from the time point of application of the refresh pulse REFP at the 2nd time. The activated refresh pulse REFP is applied at the 3rd time after the average periodic refresh interval tRFI1 elapses from the time point of applying the refresh pulse REFP at the 2nd time.

And, the above-described process is repeated.

That is, if the activated refresh pulse REFP is applied at the 3rd time, the refresh operation is performed on the word line corresponding to the row address RADD having the value of ‘1’ out of the plurality of word lines included in the 1st and 2nd memory banks 511 and 512 of the 1st memory bank group 510, and the refresh operation is performed on the word line corresponding to the row address RADD having the value of ‘1’ out of the plurality of word lines included in the 3rd memory bank 521 and the 4th memory bank 522 of the 2nd memory bank group 520.

If the activated refresh pulse REFP is applied at the 4th time, the refresh operation is performed on the word line corresponding to the row address RADD having the value of ‘1’ out of the plurality of word lines included in the 5th memory bank 531 and the 6th memory bank 532 of the 3rd memory bank group 530, and the refresh operation is performed on the word line corresponding to the row address RADD having the value of ‘1’ out of the plurality of word lines included in the 7th memory bank 541 and the 8th memory bank 542 of the 4th memory bank group 540.

The row address counter 400 changes sequentially the row address RADD having the value of ‘1’ to the row address RADD having the value of ‘2’ after the refresh cycle period tRFC2 elapses from the time point of applying the activated refresh pulse REFP at the 4th time.

If the activated refresh pulse REFP is applied at the 6th time, 8th time, . . . , 2Pth time, the value of the row address RADD is changed ‘2’ to ‘3’, ‘3’ to ‘4’, . . . , ‘P−1’ to ‘P’, respectively, and the above-described process is repeated.

That is, as shown in FIG. 5A, if the mode information MODE_INF represents the 1st mode but the modified mode information MOD_MODE_INF represents the 2nd mode, a refresh period in a memory bank group that is performed on the same memory bank group is lengthened two times more than that of the refresh operation, which is performed with the 1st mode.

For example, if the refresh operation is performed with the 1st mode, the refresh operation is performed again after the average periodic refresh interval tRFI1 elapses from the time point of performing the refresh operation on the 1st memory bank group 510. However, as shown in FIG. 5A, in the 1st mode but the modified mode information MOD_MODE_INF represents the 2nd mode, the refresh operation is performed again on the 1st memory bank group 510 after the double of the 1st average periodic refresh interval (tRFI1)×2 elapses from the time point of performing the refresh operation on the 1st memory bank group 510.

Referring to FIG. 5B, that the internal chip information CHIP_INF represents that the retention time of the memory cell is longer than the reference time, and the mode information MODE_INF represents the 2nd mode. It is assumed that an initial value of the row address RADD is ‘0’.

As shown in FIGS. 3 and 5B, the internal chip information unit 200 outputs the internal chip information CHIP_INF, which represents the information of the retention characteristic having the value of to the mode information modification unit 100.

The mode information modification unit 100 generates the modified mode information MOD_MODE_INF which represents the 3rd mode modifies by modifying the mode information MODE_INF that represents the 2nd mode based on the internal chip information CHIP_INF.

Since the modified mode information MOD_MODE_INF represents the 3rd mode, if the activated refresh pulse REFP is applied at the 1st time, the selection signal activation unit 300 activates the 1st bank group selection signal BKG_ACT1 out of four bank group selection signals BKG_ACT1 to BKG_ACT4. The 1st memory bank group 510 is selected in response to the activated 1st bank group selection signal BKG_ACT1. The refresh operation is performed on the word line corresponding to the row address RADD having the value of ‘0’ out of the plurality of word lines included in each of the 1st and 2nd memory banks 511 and 512.

Since the modified mode information MOD_MODE_INF represents the 3rd mode, the row address counter 400 changes sequentially the row address RADD whenever the activated refresh pulse REFP is applied at the 4Pth time. Thus, the row address counter 400 retains the row address RADD having the value of ‘0’ if the activated refresh pulse REFP is applied at the 1st time.

Since the mode information MODE_INF represents the 2nd mode, the refresh operation is performed with the 2nd mode in view of outside. Thus, the refresh command is applied from an external device with the average periodic refresh interval tRFI2. That is, the refresh pulse REFP is activated with the average periodic refresh interval tRFI2 and is applied to the selection signal activation unit 300 and the row address counter 400. Thus, the activated refresh pulse REFP is applied at the 2nd time after the average periodic refresh interval tRFI2 elapses from the time point of applying the activated refresh pulse REFP at the 1st time.

If the activated refresh pulse REFP is applied at the 2nd time, the selection signal activation unit 300 activates the 2nd bank group selection signal BKG_ACT2. The 2nd memory bank group 520 is selected in response to the activated 2nd bank group selection signal BKG_ACT2. The refresh operation is performed on the word line corresponding to the row address RADD having the value of ‘0’ out of the plurality of word lines included in each of the 3rd memory bank 521 and the 4th memory bank 522.

Since the modified mode information MOD_MODE_INF represents the 3rd mode, the row address counter 400 does not change the row address RADD although the activated refresh pulse REFP is applied at the 2nd time.

The activated refresh pulse REFP is applied at the 3rd time after the average periodic refresh interval tRFI2 elapses from the time point of applying the activated refresh pulse REFP at the 2nd time. If the activated refresh pulse REFP is applied at the 3rd time, the selection signal activation unit 300 activates the 3rd bank group selection signal BKG_ACT3. The 3rd memory bank group 530 is selected in response to the activated 3rd bank group selection signal BKG_ACT3. The refresh operation is performed on the word line corresponding to the row address RADD having the value of ‘0’ out of the plurality of word lines included in each of the 5th memory bank 531 and the 6th memory bank 532. The row address counter 400 does not change the row address RADD although the activated refresh pulse REFP is applied at the 3rd time.

The activated refresh pulse REFP is applied at the 4th time after the average periodic refresh interval tRFI2 elapses from the time point of applying the activated refresh pulse REFP at the 3rd time. If the activated refresh pulse REFP is applied at the 4th time, the selection signal activation unit 300 activates the 4th bank group selection signal BKG_ACT4. The 4th memory bank group 540 is selected in response to the activated 4th bank group selection signal BKG_ACT4. The refresh operation is performed on the word line corresponding to the row address RADD having the value of ‘0’ out of the plurality of word lines included in each of the 7th memory bank 541 and the 8th memory bank 542. The row address counter 400 changes the value of the row address RADD ‘0’ to ‘1’ after the refresh cycle period tRFC3 elapses from the time point of applying the activated refresh pulse REFP at the 4th time.

The activated refresh pulse REFP is applied at the 5th time after the average periodic refresh interval tRFI2 elapses from the time point of applying the activated refresh pulse REFP at the 4th time. And, the above-described process is repeated.

That is, if the activated refresh pulse REFP is applied at the 5th time, the refresh operation is performed on the word line corresponding to the row address RADD having the value of ‘1’ out of the plurality of word lines included in each of the 1st and 2nd memory banks 511 and 512 of the 1st memory bank group 510. If the activated refresh pulse REFP is applied at the 6th time, the refresh operation is performed on the word line corresponding to the row address RADD having the value of ‘1’ out of the plurality of word lines included in each of the 3rd memory bank 521 and the 4th memory bank 522 of the 2nd memory bank group 520. If the activated refresh pulse REFP is applied at the 7th time, the refresh operation is performed on the word line corresponding to the row address RADD having the value of ‘1’ out of the plurality of word lines included in each of the 5th memory bank 531 and the 6th memory bank 532 of the 3rd memory bank group 530. If the activated refresh pulse REFP is applied at the 8th time, the refresh operation is performed on the word line corresponding to the row address RADD having the value of ‘1’ out of the plurality of word lines included in each of the 7th memory bank 541 and the 8th memory bank 542 of the 4th memory bank group 540.

The row address counter 400 changes the value of the row address RADD ‘1’ to ‘2’ after the refresh cycle period tRFC3 elapses from the time point of applying the activated refresh pulse REFP at the 8th time.

If the activated refresh pulse REFP is applied at the twelfth time, the sixteenth time, . . . , the 4Pth time, the value of the row address RADD is changed ‘2’ to ‘3’, ‘3’ to ‘4’, . . . , ‘P−1’ to ‘P’, and the above-described process is repeated.

That is, as shown in FIG. 5B, if the mode information MODE_INF represents the 2nd mode but the modified mode information MOD_MODE_INF represents the 3rd mode, the refresh period in a memory bank group which is performed on the same memory bank group is lengthened two times more than that of the refresh operation which is performed with the 2nd mode.

Thus, the semiconductor memory device in accordance with the embodiment of the present application minimizes a power consumption of the refresh operation by adjusting the refresh operation to be less frequently performed if a measured retention time of a memory cell is long.

Referring to FIG. 5A, that the internal chip information CHIP_INF represents that the retention time of the memory cell is longer than the reference time, and the mode information MODE_INF represents the 1st mode. It is assumed that an initial value of the row address RADD is ‘0’.

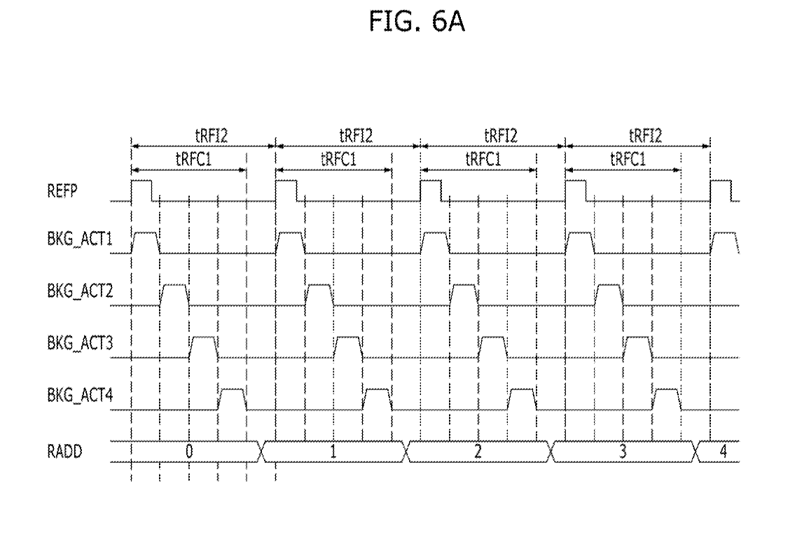

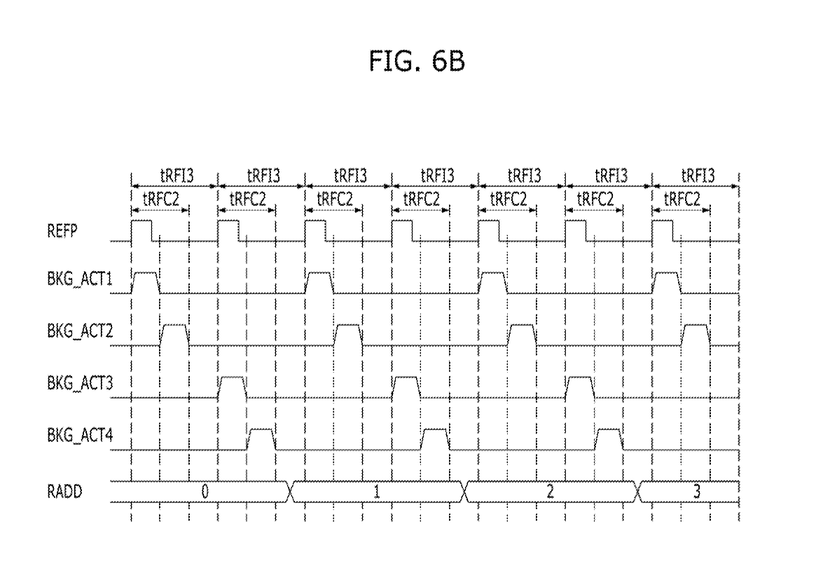

FIGS. 6A and 68 are timing diagrams illustrating a case that it is adjusted to more frequently perform refresh operations based on an internal chip information of the semiconductor memory device shown in FIG. 3.

For the convenience of the descriptions, it is assumed that the internal chip information CIHP_INF received from the internal chip information unit 200 has the temperature information, the temperature having the value of ‘1’ represents that the internal chip temperature is higher than a reference temperature, and the temperature having the value of ‘0’ represents that the internal chip temperature is lower than a reference temperature. And, the mode information modification unit 100 generates the modified mode information MOD_MODE_INF as described in the 5th table.

Referring to FIG. 6A, the internal chip information CHIP_INF represents a high temperature, and the mode information MOD_INF represents the 2nd mode. It is assumed that the row address RADD has an initial value of ‘0’.

The internal chip information unit 200 outputs the internal chip information CHIP_INF which represents the temperature information having the value of ‘1’.

The mode information modification unit 100 generates the modified mode information MOD_MODE_INF which represents the 1st mode by modifying the mode information MODE_INF which represents the 2nd mode based on the internal chip information CHIP_INF.

If the refresh command REF_CMD is applied from outside, the refresh pulse REFP is activated and output to the row address counter 400 and the selection signal activation unit 300.

Since the modified mode information MOD_MODE_INF represents the 1st mode, the selection signal activation unit 300 activates sequentially four bank group selection signals BKG_ACT1 to BKG_ACT4 if the activated refresh pulse REFP is applied at the 1st time.

The 1st bank group 510 is selected in response to the activated 1st bank group selection signal BKG_ACT1. The refresh operation is performed on the word line corresponding to the row address RADD having the value of ‘0’ out of the plurality of word lines included in each of the 1st and 2nd memory banks 511 and 512. The 2nd bank group 520 is selected in response to the activated 2nd bank group selection signal BKG_ACT2. The refresh operation is performed on the word line corresponding to the row address RADD having the value of ‘0’ out of the plurality of word lines included in each of the 3rd memory bank 521 and the 4th memory bank 522. The 3rd bank group 530 is selected in response to the activated 3rd bank group selection signal BKG_ACT3. The refresh operation is performed on the word line corresponding to the row address RADD having the value of ‘0’ out of the plurality of word lines included in each of the 5th memory bank 531 and the 6th memory bank 532. The 4th bank group 540 is selected in response to the activated 4th bank group selection signal BKG_ACT4. The refresh operation is performed on the word line corresponding to the row address RADD having the value of ‘0’ out of the plurality of word lines included in each of the 7th memory bank 541 and the 8th memory bank 542.

Since the modified mode information MOD_MODE_INF represents the 1st mode, the row address counter 400 changes sequentially the row address RADD whenever the activated refresh pulse REFP is applied once. Thus, the row address counter 400 changes the value of the row address RADD ‘0’ to ‘1’ after the refresh cycle period tRFC1 elapses from the time point of applying the activated refresh pulse REFP at the 1st time.

Since the mode information MODE_INF represents the 2nd mode, the refresh operation is performed with the 2nd mode in view of outside. Thus, the refresh command is applied from outside with the average periodic refresh interval tRFI2, e.g., 3.9 μs. That is, the refresh pulse REFP is activated with the average periodic refresh interval tRFI2, and is applied to the selection signal activation unit 300 and the row address counter 400. Thus, the activated refresh pulse REFP is applied at the 2nd time after the 2nd refresh periodic refresh interval tRFI2 elapses from the time point of applying the activated refresh pulse REFP at the 1st time.

And, the above-described process is repeated. That is, if the activated refresh pulse REFP is applied at the 2nd time, the selection signal activation unit 300 activates sequentially the 1st to 4th group selection signals BKG_ACT1 to BKG_ACT4 and the 1st to 4th memory bank groups 510 to 540 are selected in response to the activated 1st to 4th bank group selection signals BKG_ACT1 to BKG_ACT4, respectively.

The refresh operation is performed on the word line corresponding to the row address RADD having the value of ‘1’ out of the plurality of word lines included in each of the 1st and 2nd memory banks 511 and 512 of the selected 1st memory bank group 510. The refresh operation is performed on the word line corresponding to the row address RADD having the value of ‘1’ out of the plurality of word lines included in each of the 3rd memory bank 521 and the 4th memory bank 522 of the selected 2nd memory bank group 520. The refresh operation is performed on the word line corresponding to the row address RADD having the value of ‘1’ out of the plurality of word lines included in each of the 5th memory bank 531 and the 6th memory bank 532 of the selected 3rd memory bank group 530. The refresh operation is performed on the word line corresponding to the row address RADD having the value of ‘1’ out of the plurality of word lines included in each of the 7th memory bank 541 and the 8th memory bank 542 of the selected 4th memory bank group 540.

Since the modified mode information MOD_MODE_INF represents the 1st mode, the row address counter 400 changes the value of the row address RADD ‘1’ to ‘2’ after the refresh cycle period tRFC1 elapses from the time point of applying the activated 2nd refresh pulse REFP at the 2nd time.

If the activated refresh pulse REFP is applied at the 3rd time, 4th time, . . . , Pth time, the value of the row address RADD is changed from ‘2’ to ‘3’, from ‘3’ to ‘4’, from ‘P−1’ to ‘P’. The above-described process is repeated. That is, referring to FIGS. 3 and 6A, if the mode information MODE_INF represents the 2nd mode but the modified mode information MOD_MODE_INF represents the 1st mode, the refresh period in a memory bank group that is performed on the same memory bank group is shorter by two times more than that of the refresh operation that is performed with the 2nd mode.

For example, if the refresh operation is performed with the 2nd mode, the refresh operation on the 1st memory bank group 510 is performed again after two times of the 2nd average periodic refresh interval (tRIF2)×2 elapses from the time point of performing the refresh operation on the 1st memory bank group 510. However, as referring to FIG. 6A, if the mode information MODE_INF represents the 2nd mode but the modified mode information MOD_MODE_INF represents the 1st mode, the refresh operation is again performed on the 1st memory bank group after the 2nd refresh periodic refresh interval tRFI2 elapses from the time point of performing the refresh operation on the 1st memory bank group 510.

Referring to FIG. 68, the internal chip information CHIP_INF represents a high temperature, and the mode information MOD_INF represents the 3rd mode. It is assumed that the row address RADD has an initial value of ‘0’.

The internal chip information unit 200 outputs the internal chip information CHIP_INF, which represents the temperature information having the value of ‘1’, to the mode information modification unit 100. The mode information modification unit 100 generates the modified mode information MOD_MODE_INF that represents the 2nd mode by modifying the mode information MODE_INF which represents the 3rd mode based on the internal chip information CHIP_INF.

Since the modified mode information MOD_MODE_INF represents the 2nd mode, the selection signal activation unit 300 activates sequentially the 1st bank group selection signal BKG_ACT1 and the 2nd bank group selection signal BKG_ACT2 of bank group selection signals BKG_ACT1 to BKG_ACT4 when the activated refresh pulse REFP is applied at the 1st time.

The 1st memory bank group 510 is selected in response to the activated 1st bank group selection signal BKG_ACT1, and the refresh operation is performed on the word line corresponding to the row address RADD having the ‘0’ out of the plurality of word lines included in each of the 1st and 2nd memory banks 511 and 512.

The 2nd memory bank group 520 is selected in response to the activated 2nd bank group selection signal BKG_ACT2, and the refresh operation is performed on the word line corresponding to the row address RADD having the ‘0’ out of the plurality of word lines included in each of the 3rd memory bank 521 and the 4th memory bank 522.

Since the modified mode information MOD_MODE_INF represents the 2nd mode, the row address counter 400 changes sequentially the row address RADD when the activated refresh pulse REFP is applied at the 2Pth time. Thus, the row address counter 400 changes the row address RADD to have the value of ‘0’ if the activated refresh pulse REFP is applied at the 1st time.

Since the mode information MODE_INF represents the 3rd mode, the refresh operation is performed with the 3rd mode in view of outsides. Thus, the refresh command is applied from outside with the average periodic refresh interval tRFI3, e.g., 1.95 μs. That is, refresh pulse REFP is activated with the average periodic refresh interval tRFI3 and is applied to the selection signal activation unit 300 and the row address counter unit 400. Thus, the activated refresh pulse REFP is applied at the 2nd time after the average periodic refresh interval tRFI3 elapses from the time point of applying the activated refresh pulse REFP at the 1st time.

If the activated refresh pulse REFP is applied at the 2nd time, the selection signal activation unit 300 activates sequentially the 3rd bank group selection signal BKG_ACT3 and the 4th bank group selection signal BKG_ACT4. The 3rd memory bank group 530 and the 4th memory bank group 540 are selected in response to the activated 3rd bank group selection signal BKG_ACT3 and the activated 4th bank group selection signal BKG_ACT4, respectively. The refresh operation is performed on the word line corresponding to the row address RADD having the value of ‘0’ out of the plurality of word fines included in each of the 5th memory bank 531 and the 6th memory bank 532 of the selected 3rd memory bank group 530. The refresh operation is performed on the word line corresponding to the row address RADD having the value of ‘0’ out of the plurality of word fines included in each of the 7th memory bank 541 and the 8th memory bank 542 of the selected 4th memory bank group 540.

Since the modified mode information MOD_MODE_INF represents the 2nd mode, the row address counter 400 changes the value of the row address RADD ‘0’ to ‘1’ after the refresh cycle period tRFC2 elapses from the time point of applying the activated refresh pulse REFP at the 2nd time.

The activated refresh REFP is applied at the 3rd time after the average periodic refresh interval tRFI3 elapses from the time point of applying the activated refresh pulse REFP at the 2nd time. The above-described process is repeated.

That is, if the activated refresh pulse REFP is applied at the 3rd time, the selection signal activation unit 300 activates sequentially the 1st bank group selection signal BKG_ACT1 and the 2nd bank group selection signal BKG_ACT2. The 1st memory bank group 510 and the 2nd memory bank group 520 are selected in response to the activated 1st bank group selection signal BKG_ACT1 and the 2nd bank group selection signal BKG_ACT2, respectively. The refresh operation is performed on the word line corresponding to the row address RADD having the value of ‘1’ out of the plurality of word lines included in each of the 1st and 2nd memory banks 511 and 512 of the selected 1st memory bank group 510. And, the refresh operation is performed on the word line corresponding to the row address RADD having the value of ‘1’ out of the plurality of word lines included in each of the 3rd memory bank 521 and the 4th memory bank 522 of the selected 2nd memory bank group 520.

If the activated refresh pulse REFP is applied at the 4th time, the selection signal activation unit 300 activates sequentially the 3rd bank group selection signal BKG_ACT3 and the 4th bank group selection signal BKG_ACT4. The 3rd memory bank group 530 and the 4th memory bank group 540 are selected in response to the activated 3rd bank group selection signal BKG_ACT3 and the activated 4th bank group selection signal BKG_ACT4, respectively.

The refresh operation is performed on the word line corresponding to the row address RADD having the value of ‘1’ out of the plurality of word lines included in each of the 5th memory bank 531 and the 6th memory bank 532 of the selected 3rd memory bank group 530. The refresh operation is performed on the word line corresponding to the row address RADD having the value of ‘1’ out of the plurality of word lines included in each of the 7th memory bank 541 and the 8th memory bank 542 of the selected 4th memory bank group 540. The row address counter 400 changes the value of the row address RADD ‘1’ to ‘2’ after the refresh cycle period tRFC2 elapses from the time point of applying the activated refresh pulse REFP at the 4th time.

If the activated refresh pulse REFP is applied at the 6th time, 8th time, . . . , 2Pth time, the value of the row address RADD is changed from ‘2’ to ‘3’, from ‘3’ to ‘4’, . . . , from ‘P−1’ to ‘P’, and the above-described process is repeated.

That is, as shown in FIG. 68, if the mode information MODE_INF represents the 3rd mode but the modified mode information MOD_MODE_INF represents the 2nd mode, the refresh period in a memory bank group that is performed on the same memory bank group is two times shorter than that of the refresh operation that is performed with the 3rd mode.

Thus, in case that the retention time of the memory cell is short or the retention characteristic of the memory cell is lowered, the semiconductor memory device in accordance with an embodiment of the present application may retain the data on the memory cell having a short retention time and change the life time of the memory cell by adjusting the period of the refresh operation, which is performed on the same memory cell, to be short. Moreover, although a semiconductor memory device includes a memory cell having a short retention time, since the semiconductor memory device may perform an operation correctly, the semiconductor memory device is not requested to be discarded.

Meanwhile, as shown in FIGS. 5A, 5B, 6A and 6B, it is an exemplary embodiment of the present invention that the selection signal activation unit 300 activates sequentially at least one bank group selection signal in response to the refresh command once.

For example, the selection signal activation unit 300 may be designed to simultaneously activate the 1st bank group selection signal BKG_ACT1 and the 2nd bank group selection signal BKG_ACT2 when the activated refresh pulse REFP is applied at the 1st time. In this case, the refresh operation is performed on the 1st memory bank group 510 and the 2nd memory bank group 520. The bank group selection signal activation unit 300 may be designed to activate simultaneously the 3rd bank selection signal BKG_ACT3 and the 4th bank selection signal BKG_ACT4 when the activated refresh pulse REFP is applied at the 2nd time. In this case, the refresh operation is simultaneously performed on the 3rd memory bank group 530 and the 4th memory bank group 540.

According to the present invention, a refresh control circuit and a semiconductor memory device including the same may control refresh operation according to modified mode information based on the characteristics having an influence on a retention time of a memory cell. Thus, the refresh control circuit and device may perform refresh operation with adequate period thereby may prevent a memory cell with a short retention time from data loss, and a memory cell with a long retention time from unnecessary power consumption.

While the present invention has been described with respect to the specific embodiments, it will be apparent to those skilled in the art that various changes and modifications may be made without departing from the spirit and scope of the invention as defined in the following claims.

What is claimed is:

1. A refresh control circuit, comprising:
an internal chip information unit configured to provide internal chip information related to a retention characteristic of a memory cell;
a mode information modification unit configured to output modified mode information based on the internal chip information, wherein the modified mode information represent a number of memory banks for refresh operation; and
a selection signal activation unit configured to activate one or more of selection signals for selecting corresponding one or more of the memory banks in response to the modified mode information.

2. The refresh control circuit of claim 1, wherein the modified mode information represents one or more refresh modes, and
wherein each of the refresh modes have different duration and number of average periodic refresh interval to complete single refresh operation on the memory banks of the memory cell.

3. The refresh control circuit of claim 2, wherein the internal chip information includes temperature information of the memory cell.

4. The refresh control circuit of claim wherein in case that the temperature information represents a low temperature, the mode information modifying unit outputs a modified mode information indicating one of the refresh modes with a larger number of average periodic refresh interval.

5. The refresh control circuit of claim 3, wherein in case that the temperature information represents a high temperature, the mode information modifying unit outputs a modified mode information indicating one of the refresh modes with a smaller number of average periodic refresh interval.

6. The refresh control circuit of claim 2, wherein the internal chip information includes retention time information of the memory cell.

7. The refresh control circuit of claim 6, wherein in case that the retention time of the memory cell is long, the mode information modifying unit outputs a modified mode information indicating one of the refresh modes with larger number of average periodic refresh interval.

8. The refresh control circuit of claim 6, wherein in case that the retention time of a memory cell is short, the mode information modifying unit outputs a modified mode information indicating one of the refresh modes with smaller number of average periodic refresh interval.

9. The refresh control circuit of claim 2, wherein the refresh modes comprising:
1st mode where the refresh operation is performed on all of memory banks (N number of memory banks) in response to single refresh pulse;
2nd mode where the refresh operation is performed on N/2 memory banks in response to single refresh pulse; and
3rd mode where the refresh operation is performed on N/4 memory banks in response to single refresh pulse.

10. The refresh control circuit of claim 9, wherein the selection signal activation unit activates simultaneously:
all of N number of selection signals corresponding to each of the N memory banks in case that the modified mode information represents the 1st mode,
N/2 selection signals each corresponding to 2 of the N memory banks in case that the modified mode information represents the 2nd mode, and
N/4 selection signals each corresponding to 4 of the N memory bank in case that the modified mode information represents the 3rd mode.

11. The refresh control circuit of claim 9, wherein the selection signal activation unit activates sequentially:
all of N selection signals corresponding to each of the N memory banks in case that the modified mode information represents the 1st mode,
N/2 selection signals each corresponding to 2 of the N memory banks in case that the modified mode information represents the 2nd mode, and
N/4 selection signals each corresponding to 4 of the N memory bank in case that the modified mode information represents the 3rd mode.

12. The refresh control circuit of claim 2, further comprising:
a row address counter configured to change a value of a row address at every preset number of application of single refresh pulse, wherein
the preset number is the number of average periodic refresh interval to complete single refresh operation on all of the memory banks of the memory cell for the corresponding refresh mode.

13. The refresh control circuit of claim 1, wherein the internal chip information includes temperature information of the memory cell.

14. The refresh control circuit of claim 13, wherein in case that the temperature information represents a low temperature, the mode information modifying unit outputs a modified mode information indicating one of the refresh modes with larger number of average periodic refresh interval.

15. The refresh control circuit of claim 13, wherein in case that the temperature information represents a high temperature, the mode information modifying unit outputs a modified mode information indicating one of the refresh modes with smaller number of average periodic refresh interval.

16. The refresh control circuit of claim 1, wherein the internal chip information includes retention time information of the memory cell.

17. The refresh control circuit of claim 16, wherein in case that the retention time of the memory cell is long, the mode information modifying unit outputs a modified mode information indicating one of the refresh modes with larger number of average periodic refresh interval.

18. The refresh control circuit of claim 16, wherein in case that the retention time of a memory cell is short, the mode information modifying unit outputs a modified mode information indicating one of the refresh modes with smaller number of average periodic refresh interval.

19. The refresh control circuit of claim 1, further comprising:
a row address counter configured to change a value of a row address at every preset number of application of single refresh pulse, and
wherein the preset number is the number of average periodic refresh interval to complete single refresh operation on all of the memory banks of the memory cell.

20. The refresh control circuit of claim 1, wherein the plurality of memory banks includes N number of memory banks, and the mode information represents one of a first mode, a second mode and a third mode,
wherein the refresh operation is performed on all of N number memory banks in response to the refresh command once in case of the first mode, the refresh operation is performed on N/2 number memory banks in response to the refresh command once in case of the second mode, and the refresh operation is performed on N/4 number memory banks in response to the refresh command once in case of the third mode.

21. The refresh control circuit of claim 2, wherein the internal chip information providing unit includes a temperature sensing unit configured to sense an internal temperature of a chip and output temperature information, and the internal chip information has the temperature information, and
wherein in case that the temperature information represents a low temperature, if the mode information represents the first mode, the mode information modifying unit outputs a modified mode information which represents one of the second mode and the third mode, if the mode information represents the second mode, the mode information modifying unit outputs a modified mode information which represents the third mode.

22. The refresh control circuit of claim 2, wherein the internal chip information providing unit includes a temperature sensing unit configured to sense an internal temperature of a chip and output temperature information, and the internal chip information has the temperature information, and
wherein in case that the temperature information represents a high temperature, if the mode information represents the third mode, the mode information modifying unit outputs a modified mode information which represents one of the first mode and the second mode, if the mode information represents the second mode, the mode information modifying unit outputs a modified mode information which represents the first mode.

23. The refresh control circuit of claim 2, wherein the internal chip information has the process information of the chip, and
wherein in case that the process information represents that a retention time of a memory cell is long, if the mode information represents the first mode, the mode information modifying unit outputs a modified mode information which represents one of the second mode and the third mode, if the mode information represents the second mode, the mode information modifying unit outputs a modified mode information which represents the third mode.

24. The refresh control circuit of claim 2, wherein the internal chip information has the process information of the chip, and
wherein in case that the process information represents that a retention time of a memory cell is short, if the mode information represents the third mode, the mode information modifying unit outputs a modified mode information which represents one of the first mode and the second mode, if the mode information represents the second mode, the mode information modifying unit outputs a modified mode information which represents the first mode.

25. A semiconductor memory device, comprising:
N number of bank groups having at least one bank;
an internal chip information unit configured to provide internal chip information related to a retention characteristic of a memory cell;
a mode information modification unit configured to output modified mode information based on the internal chip information, wherein the modified mode information represent a number of bank groups for refresh operation;
a selection signal activation unit configured to activate one or more of selection signals for selecting corresponding one or more of the bank groups in response to the modified mode information; and
a row address counter configured to change a value of a row address at every preset number of application of single refresh pulse, wherein
the preset number is the number of average periodic refresh interval to complete single refresh operation on all of the N bank groups of the memory cell corresponding to the modified mode information.

26. The semiconductor memory device of claim 25, wherein the internal chip information includes temperature information of the memory cell.

27. The semiconductor memory device of claim 25, wherein the internal chip information includes retention time information of the memory cell.

28. The semiconductor memory device of claim 25, wherein the modified mode information represents one or more refresh modes, and
wherein each of the refresh modes has different duration and number of average periodic refresh interval to complete single refresh operation on all of the memory banks of the memory cell.

29. The semiconductor memory device of claim 28, wherein the selection signal activation unit activates:
all of N number of selection signals corresponding to each of the plurality of bank groups,
N/2 selection signals each corresponding to 2 of the N bank groups, or
N/4 selection signal each corresponding to 4 of the N bank groups.

30. The semiconductor memory device of claim 28, wherein the refresh modes comprising:
1st mode where the refresh operation is performed on all of N bank groups in response to single refresh pulse;
2nd mode where the refresh operation is performed on N/2 bank groups in response to single refresh pulse; and
3rd mode where the refresh operation is performed on N/4 bank groups in response to single refresh pulse.
